(19) United States
(12) Patent Application Publication
(10) Pub. No.: US 2026/0032590 A1
(43) Pub. Date: Jan. 29, 2026

(54) UE COOPERATION FOR UL WUS TRANSMISSION

(71) Applicant: QUALCOMM Incorporated, San Diego, CA (US)

(72) Inventors: Meilong JIANG, Westfield, NJ (US); Navid ABEDINI, Basking Ridge, NJ (US); Ahmed BEDEWY, Hillsborough, NJ (US); Naeem AKL, Bridgewater, NJ (US)

(21) Appl. No.: 18/781,707

(22) Filed: Jul. 23, 2024

(51) Int. Cl. H04W 52/02; H04W 16/28; H04W 76/10

(52) U.S. Cl. CPC H04W 52/0235; H04W 16/28; H04W 76/10

(57) ABSTRACT

The apparatus may be a wireless device such as a user equipment (UE) or component thereof configured to transmit, in association with a plurality of related UEs, an uplink (UL) wake up signal (WUS) (UL-WUS) and receive, based on the UL-WUS, system information. The apparatus may be a network node or network device such as a base station or component thereof configured to receive a single UL-WUS for a plurality of related UEs; and transmit, based on the UL-WUS, a plurality of transmissions including system information. The apparatus may be a wireless device such as a UE or component thereof configured to transmit or receive an indication that a second UE will be a delegate UE for a group of UEs including the first UE and receive system information from a network entity, where the system information is triggered by an UL-WUS for the group of UEs.

### TECHNICAL FIELD

The present disclosure relates generally to communication systems, and more particularly, to an initial access procedure for wireless communication

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) or component thereof configured to transmit, in association with a plurality of related UEs, an uplink (UL) wake up signal (WUS) (UL-WUS) and receive, based on the UL-WUS, system information.

In an aspect of the disclosure, a method, a computer-readable medium, and an apparatus are provided. The apparatus may be a wireless device such as a UE or component thereof configured to transmit or receive an indication that a second UE will be a delegate UE for a group of UEs including the first UE and receive system information from a network entity, where the system information is triggered by an UL-WUS for the group of UEs.

In an aspect of the disclosure, a method, a computer-readable medium, and an apparatus are provided. The apparatus may be a network node or network device such as a base station or component thereof configured to receive a single UL-WUS for a plurality of related UEs; and transmit, based on the UL-WUS, a plurality of transmissions including system information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram illustrating a base station receiving multiple UL-WUS in a group of UL-WUS and responding with multiple SI/SSB transmissions in a group of triggered SI/SSBs without a UE cooperation group.

FIG. 5 is a diagram illustrating an environment in which a UE cooperation group may be used in accordance with some aspects of the disclosure.

FIG. 6 is a diagram illustrating the use of a common UL-WUS for a UE cooperation group in accordance with some aspects of the disclosure.

FIG. 7 is a diagram illustrating a UE receiving the SI/SSB and providing the SI/SSB information to a set of additional UEs in accordance with some aspects of the disclosure.

FIG. 8 is a diagram illustrating a method for transmitting a common UL-WUS using a SFN transmission in accordance with some aspects of the disclosure.

FIG. 9 is a call flow diagram illustrating a method of wireless communication in accordance with some aspects of the disclosure.

FIG. 10 is a call flow diagram illustrating a method of wireless communication in accordance with some aspects of the disclosure.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

In some aspects of wireless communication, e.g., 5G NR among other examples, a UE in idle mode and/or in radio resource control (RRC) inactive state may acquire system information (SI), for transmitting a paging message, and for radio access network (RAN) Area registration. Using a layer 2 (L2) UE to network (U2N) framework, a remote UE (e.g., a U2N remote UE) may use a U2N relay UE to perform one or more of the procedures, in a unicast mode of operation (one relay UE helping and/or serving as a relay for one remote UE). In some aspects of wireless communication, a network energy savings (NES) technique may be used in which a cell may not periodically broadcast an associated (first) system information block (SIB1) and/or remaining minimum system information (RMSI). An anchor cell, in some aspects, may provide a copy of a NES cell's SIB1 and/or the NES cell may transmit SIB1 in response to a request, e.g., an on-demand SIB1 based on a request from a UE.

Various aspects relate generally to a scheme to effectively, for a group of UEs in idle/inactive mode, send UL-WUS through UE delegation and/or cooperation. Some aspects more specifically relate to a delegate UE in a UE cooperation framework (e.g., in a UE cooperation group) that sends UL-WUS for on-demand synchronization signal block (SSB) or OSI to avoid multiple UEs sending independent (e.g., different) requests to the network. For example, instead of having multiple UEs send multiple WUS requests for the base station (e.g., a NES cell) one delegate UE may send a common UL-WUS request on behalf of the group. In some aspects, to increase the coverage of the UL-WUS multiple UEs can send the same message as a single frequency network (SFN) transmission (e.g., a coherently received signal at the base station transmitted by multiple UEs within the UE cooperation group), or use one delegate UE that is closer to the base station and/or has a stronger link/connection. The delegate UE, in some aspects, may also share the base station feedback (e.g., may provide system information received from the base station to the other members of the UE cooperation group or may provide information regarding an acknowledgment (ACK) related to the common UL-WUS). In some examples, a wireless device such as a UE or component thereof may be configured to transmit, in association with a plurality of related UEs, an UL-WUS and receive, based on the UL-WUS, system information (e.g., SIB1 or OSI). In some aspects, a network node or network device such as a base station or component thereof may be configured to receive a single UL-WUS for a plurality of related UEs; and transmit, based on the UL-WUS, a plurality of transmissions including system information. In some examples, a wireless device such as a UE or component thereof may be configured to transmit or receive an indication that a second UE will be a delegate UE for a group of UEs including the first UE and receive system information from a network entity, where the system information is triggered by an UL-WUS for the group of UEs.

Particular aspects of the subject matter described in this disclosure can be implemented to realize one or more of the following potential advantages. In some examples, by identifying a UE cooperation group for receiving on-demand SI and using one or more delegate UEs to transmit an UL-WUS, the described techniques can be used to reduce a power consumption and overhead associated with the retrieval of SI.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

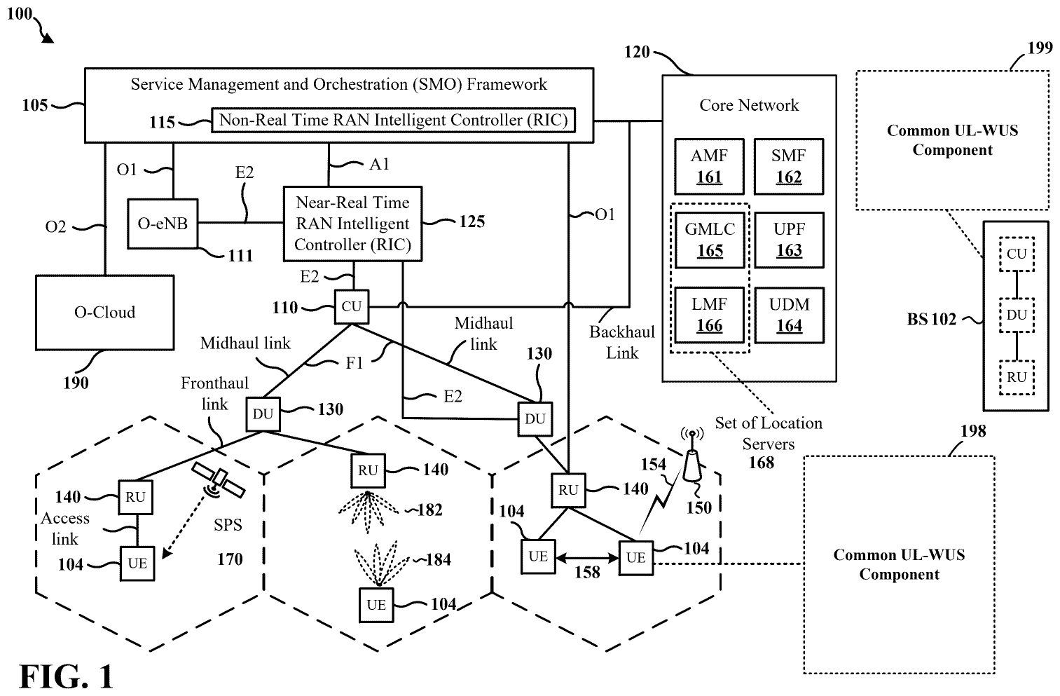

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a common UL-WUS component 198 that may be configured to transmit, in association with a plurality of related UEs, an UL-WUS and receive, based on the UL-WUS, system information. In certain aspects, the common UL-WUS component 198 may be configured to transmit or receive an indication that a second UE will be a delegate UE for a group of UEs including the first UE and receive system information from a network entity, where the system information is triggered by an UL-WUS for the group of UEs. In certain aspects, the base station 102 may have a common UL-WUS component 199 that may be configured to receive a single UL-WUS for a plurality of related UEs; and transmit, based on the UL-WUS, a plurality of transmissions including system information. Although the following description may be focused on 5G NR, the concepts described herein may be applicable to other similar areas, such as LTE, LTE-A, CDMA, GSM, and other wireless technologies.

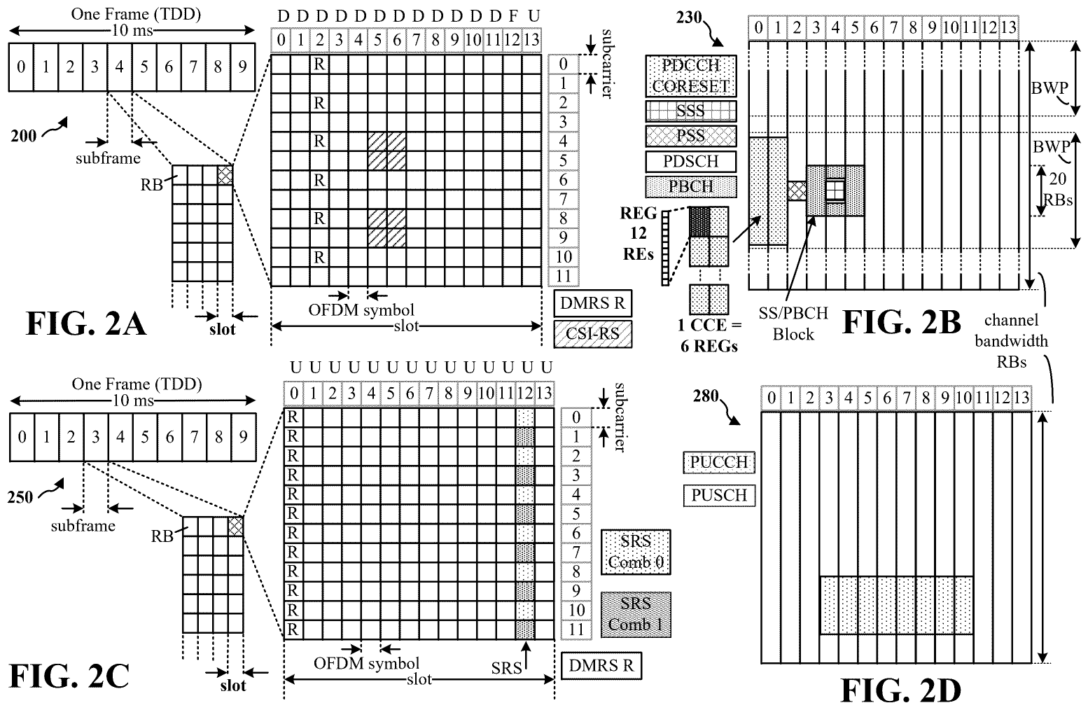

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

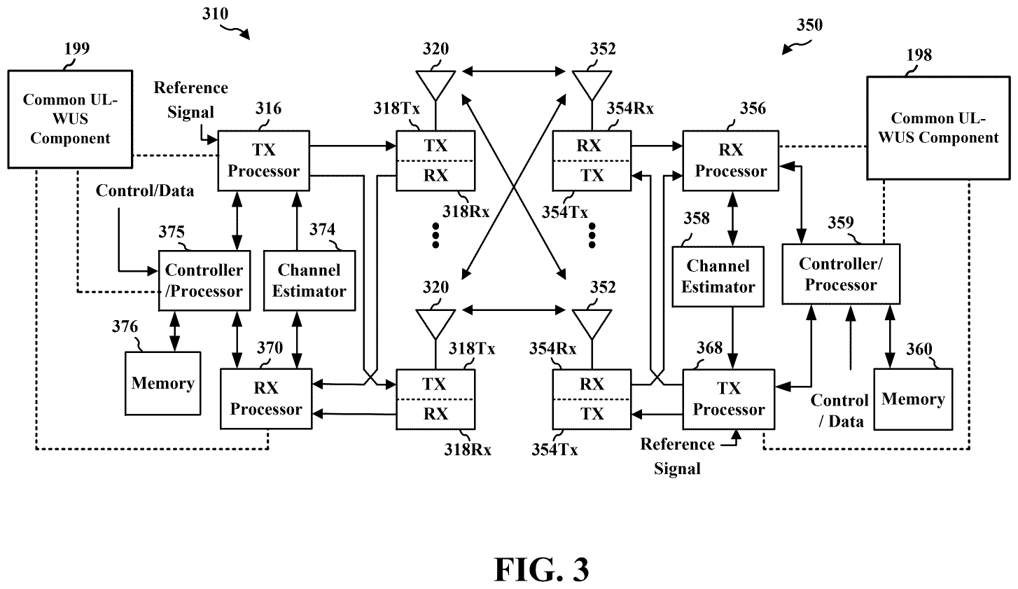

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the common UL-WUS component 198 of FIG. 1.

At least one of the TX processor 316, the RX processor 370, and the controller/processor 375 may be configured to perform aspects in connection with the common UL-WUS component 199 of FIG. 1.

In some aspects of wireless communication, e.g., 5G NR, a UE in idle mode and/or in RRC inactive state may acquire SI, for transmitting a paging message, and for RAN Area registration. Using a L2 U2N framework, a remote UE (e.g., a U2N remote UE) can rely on a U2N relay UE to perform one or more of the procedures, in a unicast mode of operation (one relay UE helping and/or serving as a relay for one remote UE). In some aspects of wireless communication, a NES technique may be used in which a cell may not periodically broadcast an associated SIB and/or RMSI (e.g., SIB1). An anchor cell, in some aspects, may provide a copy of a NES cell's SIB1 and/or the NES cell may transmit SIB1 in response to a request, e.g., an on-demand SIB1 based on a request from a UE.

Various aspects relate generally to a scheme to effectively, for a group of UEs in idle/inactive mode, send UL-WUS through UE delegation and/or cooperation. Some aspects more specifically relate to a delegate UE in a UE cooperation framework (e.g., in a UE cooperation group) that sends UL-WUS for on-demand SSB or OSI to avoid multiple UEs sending independent (different) requests to the network. For example, instead of having multiple UEs send multiple WUS requests for the base station (e.g., a NES cell) one delegate UE may send a common UL-WUS request on behalf of the group. In some aspects, to increase the coverage of the UL-WUS multiple UEs can send the same message as a SFN transmission (e.g., a coherently received signal at the base station transmitted by multiple UEs within the UE cooperation group), or use one delegate UE that is closer to the base station and/or has a stronger link/connection. The delegate UE, in some aspects, may also share the base station feedback (e.g., may provide system information received from the base station to the other members of the UE cooperation group or may provide information regarding an ACK related to the common UL-WUS). In some examples, a wireless device such as a UE or component thereof may be configured to transmit, in association with, or on behalf of, a plurality of related UEs, an UL-WUS and receive, based on the UL-WUS, system information (e.g., SIB1 or OSI). In some aspects, a network node or network device such as a base station or component thereof may be configured to receive a single UL-WUS for a plurality of related UEs; and transmit, based on the UL-WUS, a plurality of transmissions including system information. In some examples, a wireless device such as a UE or component thereof may be configured to transmit or receive an indication that a second UE will be a delegate UE for a group of UEs including the first UE and receive system information from a network entity, where the system information is triggered by an UL-WUS for the group of UEs transmitted by the delegate UE.

Particular aspects of the subject matter described in this disclosure can be implemented to realize one or more of the following potential advantages. In some examples, by identifying a UE cooperation group for receiving on-demand SI and using one or more delegate UEs to transmit an UL-WUS, the described techniques can be used to reduce a power consumption and overhead associated with the retrieval of SI. A UE cooperation group, in some aspects may alternatively be referred to as a UE collaboration group, a common UL-WUS UE group, or other similar terms indicating that the UEs in the group are associated with a delegated set of one or more UE(s) for transmitting a (common) UL-WUS on behalf of other members of the group.

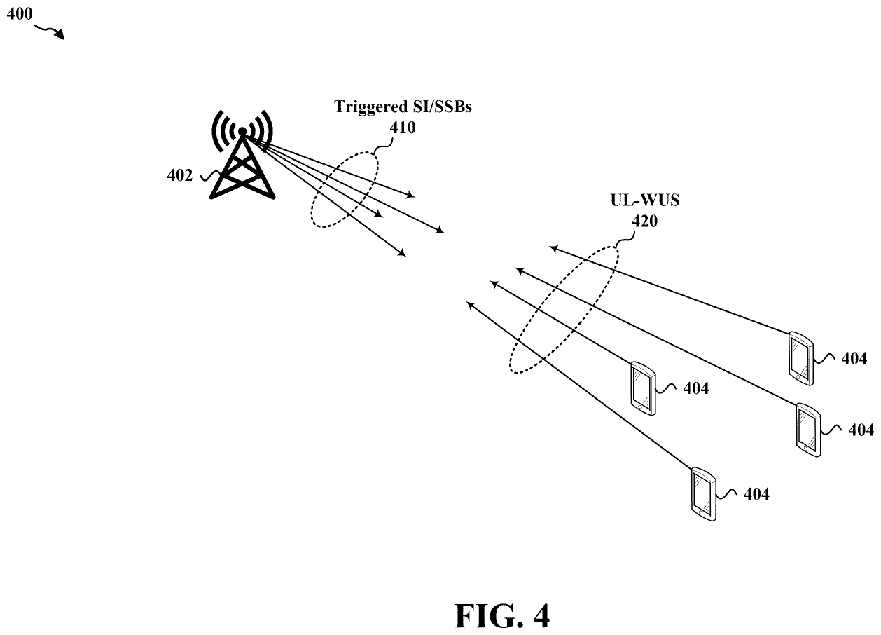

FIG. 4 is a diagram 400 illustrating a base station 402 receiving multiple UL-WUSs (e.g., requests for an SSB and/or SI) in a group of UL-WUS 420 and responding with multiple SI/SSB transmissions in a group of triggered SI/SSBs 410 not using a UE cooperation group. Diagram 400 illustrates that in some aspects, each UE 404 of a set of multiple UEs may transmit an independent UL-WUS (e.g., a request for SI) in the group of UL-WUS 420. Similarly, the base station 402 (e.g., a NES cell) may, in response to the multiple received UL-WUS and/or requests, transmit multiple independent SI/SSBs in the group of triggered SI/SSBs 410. These multiple transmissions (e.g., requests and responses), in some aspects, may be associated with excessive overhead (e.g., sending the same information via multiple SI/SSB transmissions to each of the UEs 404) and excessive power consumption at both the base station 402 and the UEs 404 (e.g., power consumption associated with transmitting the requests and responses as well as monitoring for the multiple UL-WUS and SI/SSB transmissions).

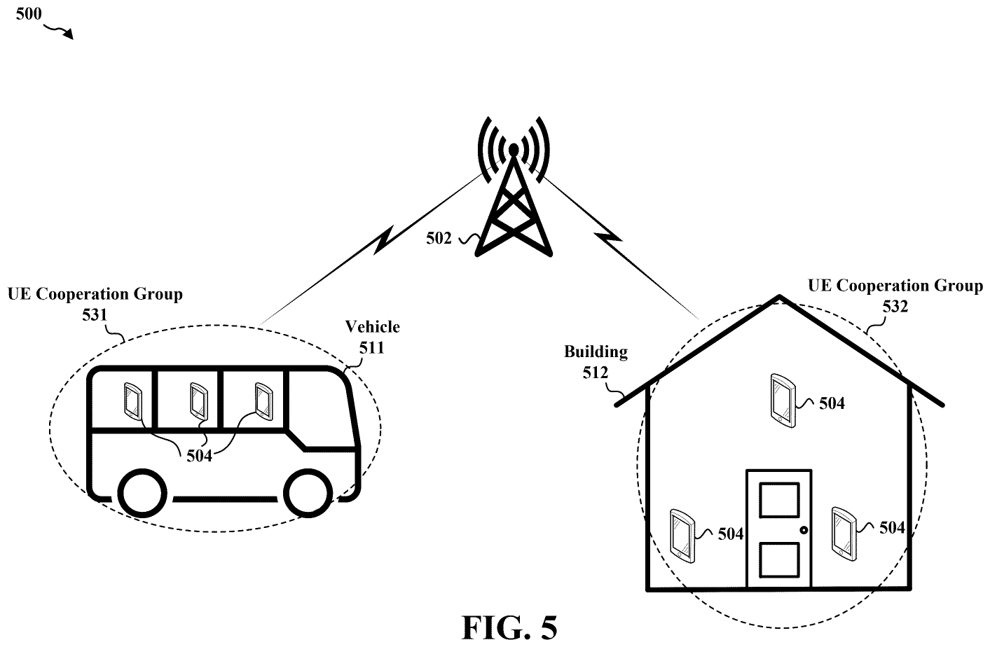

FIG. 5 is a diagram 500 illustrating an environment using a UE cooperation group in accordance with some aspects of the disclosure. Diagram 500 illustrates that a first group of UEs 504 that move together because they are “collocated” within a vehicle 511 may be associated with a first UE cooperation group 531 based on the “collocation” within the vehicle 511. Diagram 500 also illustrates that a second group of UEs 504 that are “collocated” at a same location, e.g., building 512, may be associated with a second UE cooperation group 532 based on the “collocation” within the building 512. In these examples, “collocation” may refer to physical proximity, and may further refer to sharing a common cell (e.g., base station 502) and/or a beam (being associated with a same SSB). The UEs 504, in some aspects, may belong to a same public land mobile network (PLMN) or different PLMNs. In some aspects, the UEs 504 may all be operating in an inactive and/or idle mode of operation (e.g., in inactive/idle mode) or at least one UE 504 in one or both of the first UE cooperation group 531 and/or the second UE cooperation group 532 may be in a connected mode of operation (e.g., in connected mode) with the remaining UEs 504 being in the inactive/idle mode.

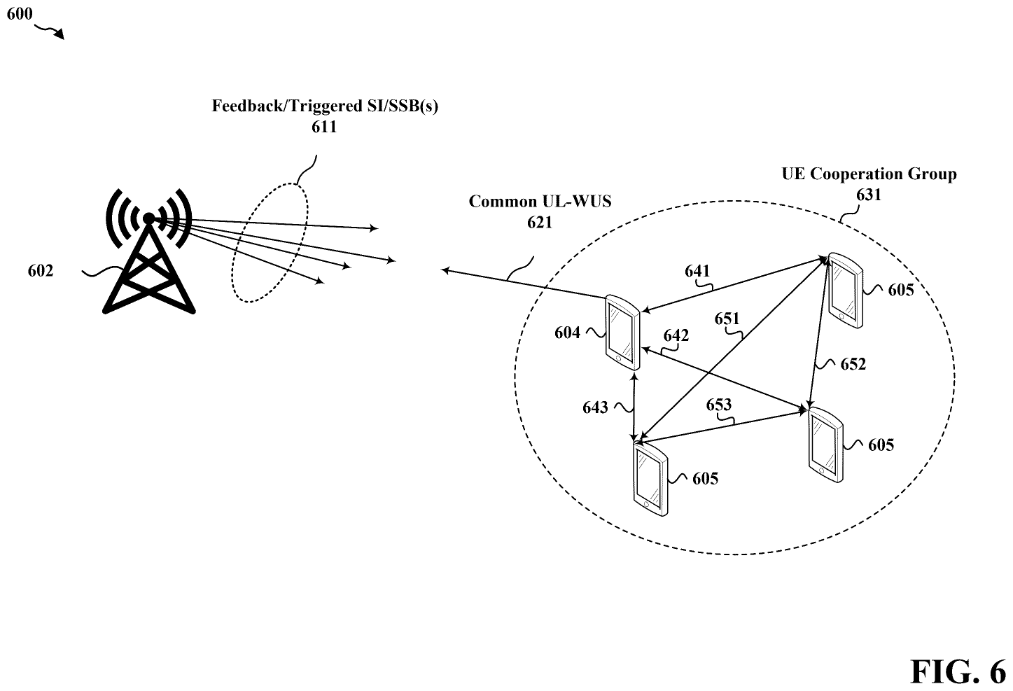

FIG. 6 is a diagram 600 illustrating the use of a common UL-WUS 621 for a UE cooperation group 631 in accordance with some aspects of the disclosure. Diagram 600 illustrates a UE cooperation group 631 (which may, in some aspects, be referred to as a (UE) coordination group) including a UE (e.g., a delegate UE 604 and/or a delegated UE) serving as a delegate UE for a set of UEs (e.g., non-delegate UEs 605). The non-delegate UEs may communicate with the delegate UE (e.g., may exchange communications 641, communications 642, and communications 643). The communication, in some aspects, may include a coordination (e.g., a signaling handshake) to determine which UE (or set of UEs) in the UE cooperation group 631 will serve as the delegate UE(s). The delegate, in some aspects, may be selected based on one or more criteria, e.g., a proximity to the base station, already being in a connected state, or other appropriate criteria. In some aspects, the communication may further include signaling and/or communications related to determining the membership in the group and/or a group identifier (ID) associated with the UE cooperation group 631.

In some aspects, the communications 641, 642, and 643, may include an UL-WUS request from one or more of the non-delegate UEs in the UE cooperation group 631. Based on the UL-WUS requests from one or more non-delegate UEs, the delegate UE(s) may transmit common UL-WUS 621 (e.g., a single UL-WUS on behalf of the UEs associated with a received UL-WUS request). In some aspects, the different UL-WUS requested by the non-delegate (and delegate) UEs may be associated with different beam directions (e.g., different SSBs), where the different beam directions may be indicated by the common UL-WUS 621. The UL-WUS, in some aspects, may indicate the multiple directions and associated SI/SSB requested explicitly. In some aspects, the multiple beam directions and/or the requested SI/SSB(s) may be identified based on a group ID included in the common UL-WUS 621. For example, a group ID may be associated with one or more beam directions associated with the UEs in the UE cooperation group 631. A group ID may be useful, for example, for a stationary (or pseudo-stationary) group of UEs.

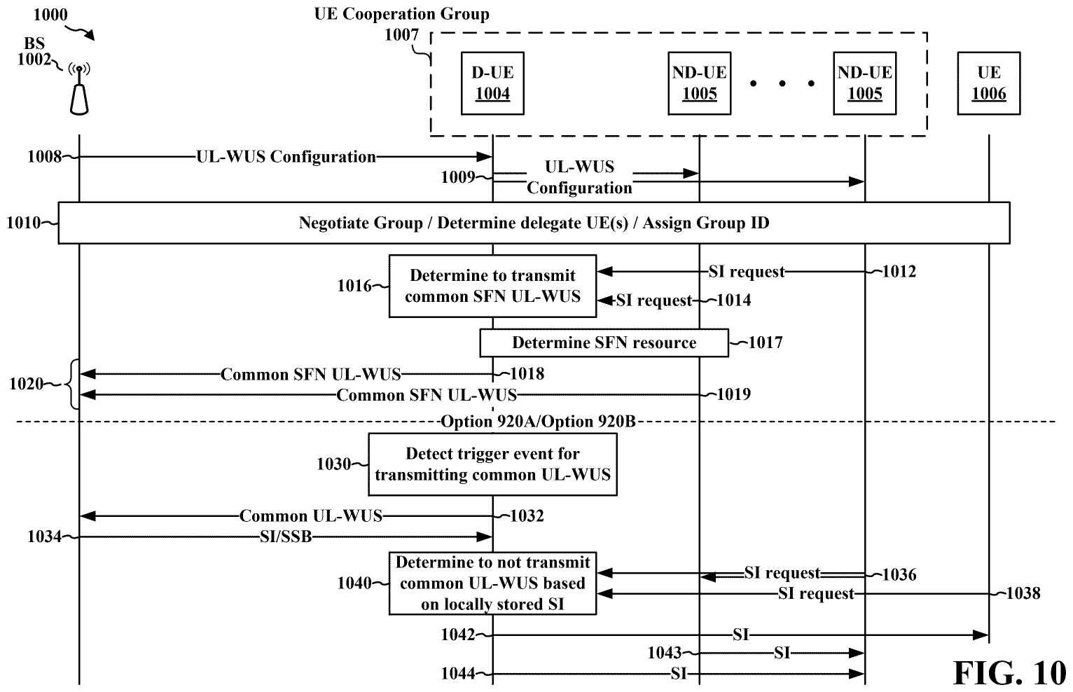

The delegate UE(s) may monitor for, and the base station 602 may respond to the common UL-WUS 621 with, feedback (e.g., in the set of feedback and/or triggered SI/SSB(s) 611) regarding the common UL-WUS 621. Upon receiving the feedback, the delegate UE(s) may broadcast/multicast/unicast the information (e.g., SI/SSB information) included in the feedback to the requesting non-delegate UE(s). In some aspects, the requesting non-delegate UE(s) may monitor for the feedback regarding the common UL-WUS 621 and for the subsequent SI/SSB(s) in the set of feedback and/or triggered SI/SSB(s) 611. For example, the set of feedback and/or triggered SI/SSB(s) 611 may be transmitted in the multiple directions indicated in the common UL-WUS 621. If a UE in the UE cooperation group 631 fails to receive SI and/or an SSB activated by the common UL-WUS 621, in some aspects, the UE may resend the UL-WUS request to the delegate UE(s) (e.g., delegate UE(s) of UE cooperation group 631 or another nearby and/or overlapping UE coordination group) as described above and/or attempt to retrieve it from a UE in the UE cooperation group 631 (or the other nearby and/or overlapping UE coordination group) as described below in relation to, for example, FIG. 10. Similarly, UEs wanting and/or requesting the SI/SSB at a later time (e.g., after the transmission of the common UL-WUS 621) may receive and/or retrieve the information from the delegate UE(s) or one or more other UEs that successfully received the information (e.g., the SI/SSB) as one or more of communications 651, communications 652, and/or communications 653.

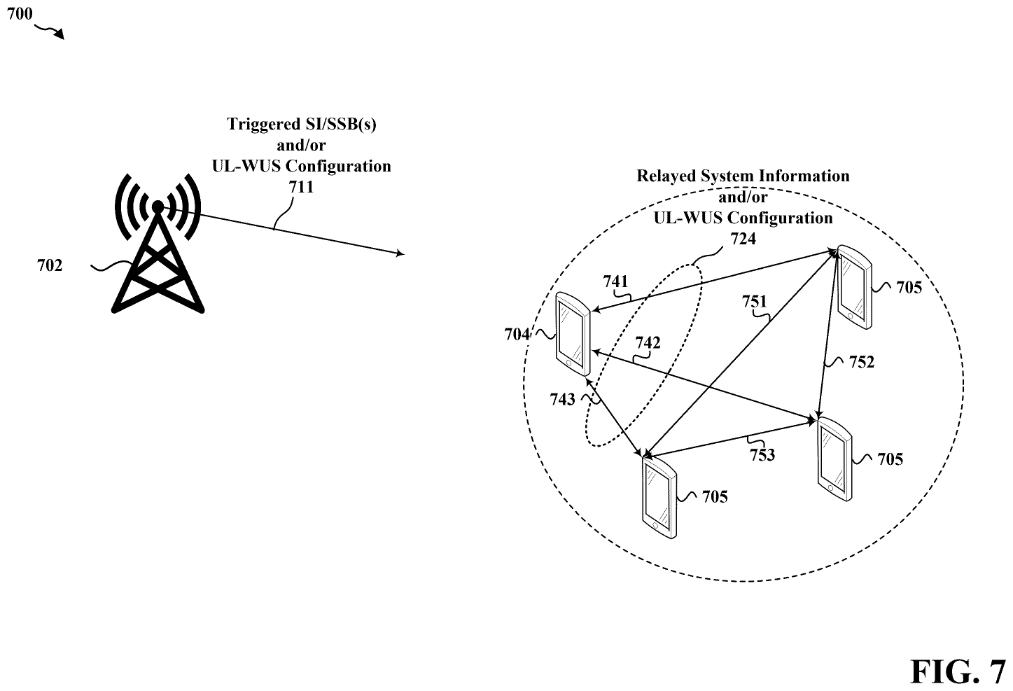

FIG. 7 is a diagram 700 illustrating a delegate UE 704 receiving the SI/SSB and providing the SI/SSB information to a set of additional UEs 705 in accordance with some aspects of the disclosure. In some aspects, one or more delegate UE(s) may acquire SI and share it with other UEs, which may be applicable for SIB-less operation as well. For example, the delegate UE(s) may transmit a common UL-WUS, receive the SI/SSB(s) (e.g., included in the set of triggered SI/SSB(s) and/or UL-WUS configuration 711), and communicate with the non-delegate (assisted) UE(s) (e.g., the set of additional UEs 705). In some aspects, the communication with the non-delegate UE(s) may be via a local, short-range, and/or low-power link (e.g., link 741, link 742, and/or link 743), using any technology. For example, the communication between a delegate UE (e.g., delegate UE 704) and a non-delegate UE (e.g., one of the additional UEs 705) may utilize a low power (LP)-WUS for its local communication, where the UEs Master Radio may be in deep sleep. In some aspects, the delegate UE(s) may act as a L2 U2N relay UE for each UE in the set of additional UEs 705 and may share (or provide) the SI acquired by the delegate UE(s) to each remote UE (e.g., the set of additional UEs 705 acting in the role of a U2N remote UE) based on time-division multiplexing (TDM). In some aspects, the SI acquired by the delegate UE(s) may be locally multicast/broadcast.

In some aspects, the one or more delegate UE(s) may acquire configuration information for a UE coordination group and/or a common UL-WUS configuration and share it with other UEs. For example, the delegate UE(s) may receive the information for the UE coordination group and/or the common UL-WUS configuration via the set of triggered SI/SSB(s) and/or UL-WUS configuration 711 and communicate the information with the non-delegate (assisted) UE(s) (e.g., the set of additional UEs 705). In some aspects, the communication involving the non-delegate UE(s) may be via a local, short-range, and/or low-power link (e.g., link 741, link 742, link 743, link 751, link 752, and/or link 753), using any technology. For example, the communication may utilize a LP-WUS for its local communication, where the UEs Master Radio may be in deep sleep. In some aspects, the delegate UE(s) may act as a L2 U2N relay UE for each UE in the set of additional UEs 705 and may share (or provide) the configuration information acquired by the delegate UE(s) to each remote UE (e.g., the set of additional UEs 705 acting in the role of a U2N remote UE) based on TDM. In some aspects, the information for the UE coordination group and/or the common UL-WUS configuration acquired by the delegate UE(s) may be locally multicast/broadcast (e.g., as relayed SI and/or UL-WUS configuration 724).

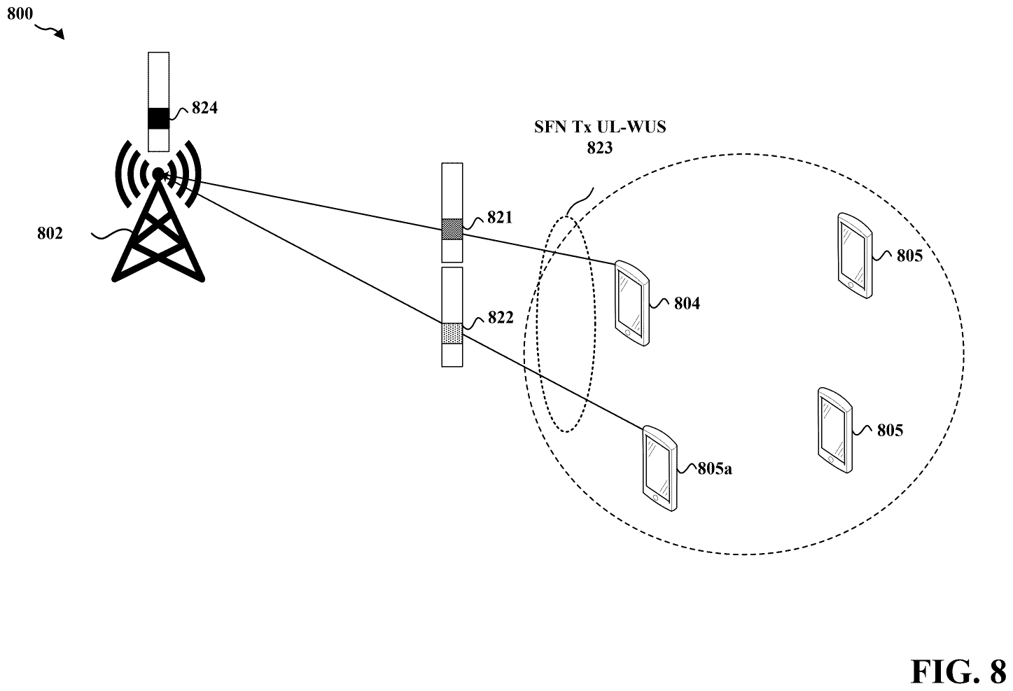

FIG. 8 is a diagram 800 illustrating a method for transmitting a common UL-WUS using a SFN transmission in accordance with some aspects of the disclosure. In some aspects where uplink coverage or link budget is an issue, in order to more reliably transmit a common UL-WUS, a set of two or more UEs may transmit the UL-WUS such that the multiple transmissions experience constructive interference at the base station 802. For example, the set of two or more UEs may include at least two delegate UEs or at least one delegate UE (e.g., delegate UE 804) and at least one non-delegate UE with a strong connection or a next-nearest UE (e.g., UE 805a) after the delegate UE may transmit a UL-WUS 823 as an SFN transmission (e.g., a SFN UL-WUS). For example, the delegate UE 804 may transmit SFN UL-WUS 821 with a first power (P₁) and the UE 805a may transmit the SFN UL-WUS 822 with a second power (P₂) that make up the SFN transmission of the UL-WUS 823 and that is received as UL-WUS 824 with a power/strength that is based on both P₁ and P₂. In some aspects, the UL SFN (e.g., the SFN UL-WUS) may use one of a predefined (e.g., by the network), or locally-coordinated, UL SFN RB allocation (a specific time-and-frequency resource or set of resources).

In some aspects, the multiple UEs may coordinate with each other to determine which UL-WUS occasion to use for transmitting the combined and/or common SFN UL-WUS TX. The multiple UEs may, in some aspects, coordinate and adjust their transmission timing and/or transmission power to achieve coherent reception (e.g., constructive interference) at the network.

In any of the aspects described above in relation to FIGS. 6-8, the transmission of the common UL-WUS (e.g., the common UL-WUS 621 or the (SFN) UL-WUS 823) may be triggered by one or multiple assisted and/or non-delegate UEs within a UE cooperation group sending a local exchange request (such as UL-WUS for SIB1 or an indication of other requested SI). In relation to the description of FIG. 7 above, the common UL-WUS may be transmitted if the delegate UE(s) and/or the other non-delegate UEs in the UE cooperation group have not acquired and stored the requested information locally. In some aspects, the locally stored information may be subject to expiration such that, even if another UE in the UE cooperation group has acquired and stored the requested information, the delegate UE(s) may transmit the common UL-WUS if the corresponding acquired and stored information has expired.

In some aspects, the transmission of the common UL-WUS (e.g., the common UL-WUS 621 or the (SFN) UL-WUS 823) may be triggered by one and/or multiple assisted and/or non-delegate UEs within a UE cooperation group sending a request for updating on-demand SIB1 and/or OSI via local communication (e.g., not using a UL-WUS in a format recognized by a base station such as a NES cell). Requests from different assisted and/or non-delegate UEs, in some aspects, may be different (e.g., for different SI). In some aspects, the transmission of the common UL-WUS (e.g., the common UL-WUS 621 or the (SFN) UL-WUS 823) from the delegate UE(s) may be transmitted proactively (e.g., without being requested by assisted and/or non-delegate UEs). In such aspects, the SI retrieved proactively may then be shared with other UEs. For example, the delegate UE(s) may periodically, or based on a triggering event such as an expiration of particular SI, retrieve (a corresponding) SI. Triggering events for proactively requesting particular SI (e.g., SIB1 or OSI), in some aspects, may include one or more of (1) the particular SI being updated, (2) the selection of a new cell for camping, (3) a quality of a camped cell degrading more than a threshold, (4) a quality of a neighbor cell improving more than a threshold, (5) a change in the mobility state, (6) entering and/or exiting the coverage of a specific cell, beam, zone, etc., or any other condition associated with UE mobility (See, e.g., Table 2).

TABLE 2
Measurement Events

| Event Type | Purpose of events |
|---|---|
| Event A1 | Serving becomes better than threshold |
| Event A2 | Serving becomes worse than threshold |
| Event A3 | Neighbor becomes offset better than a special |
| | cell (SpCell) |
| Event A4 | Neighbor becomes better than threshold |
| Event A5 | SpCell becomes worse than threshold1 and |
| | neighbor becomes better than threshold2 |
| Event A6 | Neighbor becomes offset better than SCell |
| Event B1 | Inter RAT neighbor becomes better than threshold |
| Event B2 | PCell becomes worse than threshold1 and inter |
| | RAT neighbor becomes better than threshold2 |
| Event I1 | Interference becomes higher than threshold |
| Event C1 | The NR sidelink channel busy ratio is above a |
| | threshold |
| Event C2 | The NR sidelink channel busy ratio is below a |
| | threshold |
| Event D1 | Distance between UE and referenceLocation1 is |
| | above threshold1 and distance between UE and |
| | referenceLocation2 is below threshold2 |
| CondEvent | Time measured at UE is within a duration from |
| T1 | threshold |
| Event X1 | Serving L2 U2N Relay UE becomes worse than |
| | threshold1 and NR Cell becomes better than |
| | threshold2 |
| Event X2 | Serving L2 U2N Relay UE becomes worse than |
| | threshold |
| Event Y1 | PCell becomes worse than threshold1 and candidate |
| | L2 U2N Relay UE becomes better than threshold2 |
| Event Y2 | Candidate L2 U2N Relay UE becomes better than |
| | threshold |

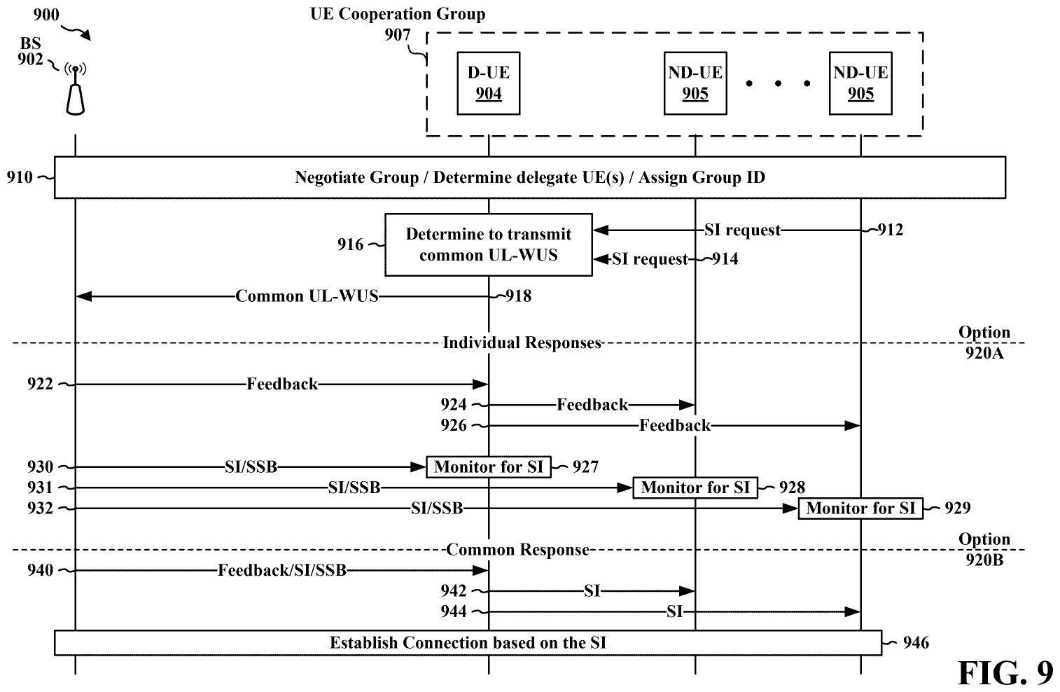

FIG. 9 is a call flow diagram 900 illustrating a method of wireless communication in accordance with some aspects of the disclosure. The method is illustrated in relation to a base station 902 (e.g., as an example of a network device or network node that may include one or more components of a disaggregated base station) in communication with a set of UEs (e.g., including delegate UE 904 and at least one non-delegate UE 905 in a UE cooperation group 907 as examples of wireless devices). The functions ascribed to the base station 902, in some aspects, may be performed by one or more components of a network entity, a network node, or a network device (a single network entity/node/device or a disaggregated network entity/node/device as described above in relation to FIG. 1). Similarly, the functions ascribed to a UE (e.g., the delegate UE 904 and/or non-delegate UE 905), in some aspects, may be performed by one or more components of a wireless device supporting communication with a network entity/node/device. Accordingly, references to “transmitting” in the description below may be understood to refer to a first component of the base station 902 (or the delegate UE 904) outputting (or providing) an indication of the content of the transmission to be transmitted by a different component of the base station 902 (or the delegate UE 904). Similarly, references to “receiving” in the description below may be understood to refer to a first component of the base station 902 (or the delegate UE 904) receiving a transmitted signal and outputting (or providing) the received signal (or information based on the received signal) to a different component of the base station 902 (or the delegate UE 904).

In some aspects, the base station 902, the delegate UE 904, and the non-delegate UEs 905 (which may generally be a set of one or more UEs) may, at 910, negotiate a group definition and membership, determine one or more delegate UE(s) for a defined/determined group (e.g., a UE cooperation group), and assign/identify/determine a group ID for the determined group. In some aspects, the definition and/or membership of the UE cooperation group 907 may be determined at 910 based on camping on a same cell, using a same or similar set of beams, and/or being in a similar location (e.g., within a threshold distance of a particular location or within a threshold distance from a UE such as the delegate UE or a centrally located UE in the cooperation group). In some aspects, the negotiation, determination, and assigning may be based on a configuration for a common UL-WUS obtained by the UEs in the UE cooperation group 907 and/or the specific implementation of the common UL-WUS (e.g., SFN UL-WUS, common UL-WUS, independent and/or multiple feedback/SI/SSB transmission, using a “relay-style” delegate UE, etc.). In some aspects, the common UL-WUS may include cell-specific information. The operations at 910, in some aspects, may be based on various communications (signaling, indications, and/or “handshakes”) that allow the candidate UEs to determine if they belong to a same cooperation and/or coordination group and/or to determine at least one delegate UE (e.g., information relating to delegate selection criteria such as distance from a base station, a link quality/budget with the base station, etc.).

After determining the group configuration and identifying the delegate UE 904, the non-delegate UEs 905 may transmit, and the delegate UE 904 may receive, a first request for SI (e.g., SI request 912) and a second request for SI (e.g., SI request 914), where each request for SI may be a request for a different one of a SIB1, an SSB, or OSI. Based on at least one of the SI request 912 or the SI request 914, the delegate UE 904 may determine, at 916, to transmit a common UL-WUS. For example, the delegate UE 904 may determine, at 916, that the delegate UE 904 does not store the requested SI and/or that a threshold number of requests has been received, where the threshold may be as low as 1 in some aspects. Based on the determination at 916, the delegate UE may transmit, and the base station 902 may receive, a common UL-WUS 918 (e.g., a request for SI/SSB).

In relation to a first implementation (e.g., associated with individual responses as illustrated in option 920A), the common UL-WUS 918 may include an indication of one or more requests for SI/SSB associated with a same and/or different SI/SSB(s) and or one or more directions associated with the one or more requests. The indication in some aspects, may be a group ID (e.g., as negotiated and/or identified at 910) that identifies the members of the UE cooperation group 907. Based on the common UL-WUS 918, the base station 902 may transmit, and the delegate UE 904 may receive, feedback 922 (e.g., an ACK indicating that the base station received the common UL-WUS) and forward the feedback 922 as the feedback 924 and the feedback 926 (or provide an indication of the relevant content of the feedback 922 for a first and second non-delegate UE as the feedback 924 and 926) to the non-delegate UEs 905. In some aspects, the feedback 922, 924, and 926 may indicate resources to be monitored by the UEs (e.g., the delegate UE 904 and the non-delegate UEs 905) to acquire the SI/SSB. Accordingly, the delegate UE 904 and the non-delegate UEs 905 may monitor for the SI at 927, 928, and 929. The base station 902 may transmit, and the delegate UE 904 and the non-delegate UEs 905 may receive the requested SI/SSB 930, 931, and 932 via a set of time-and-frequency resources monitored at 927, 928, and 929, respectively.

Alternatively, or additionally, in relation to a second implementation (e.g., associated with a single/common response to the delegate UE 904 as illustrated in option 920B), the common UL-WUS 918 may be associated with a “U2N relay” delegate UE (where the delegate UE may not fulfill all the functions of a U2N relay UE, but act as a relay UE in some aspects relating to retrieving the SI/SSB) such that it may not include information regarding the non-delegate UEs associated with (e.g., triggering) the common UL-WUS 918. In some aspects using a “U2N relay” delegate UE, the base station 902 may transmit, and the delegate UE 904 may receive, the feedback and/or SI/SSB 940. The delegate UE 904 may then provide (e.g., transmit using a wireless transmission using any of a number of different local, short-range, and/or low-power links) SI 942 and SI 944 to non-delegate UEs 905, where providing the SI 942 and 944 may be via unicast (based on TDM), multi-cast/groupcast, and/or broadcast transmission. In some aspects, options 920A and 920B may not be exclusive and may be used as a primary or secondary option/mechanism/implementation for acquiring the SI/SSB (where either option may be used as the primary and/or the secondary option/mechanism/implementation). Based on the SI/SSB acquired via either option 920A and/or 920B (SI 942 and/or SI 944), the non-delegate UE 905 (as a non-limiting example of a UE in the UE cooperation group 907) may, at 946, establish a connection with the base station 902 (e.g., may transition from an idle/inactive state to a connected/active state).

FIG. 10 is a call flow diagram 1000 illustrating a method of wireless communication in accordance with some aspects of the disclosure. The method is illustrated in relation to a base station 1002 (e.g., as an example of a network device or network node that may include one or more components of a disaggregated base station) in communication with a set of UEs (e.g., including delegate UE 1004 and at least one non-delegate UE 1005 in a UE cooperation group 1007 and a UE 1006 not included in the UE cooperation group 1007 as examples of wireless devices). The functions ascribed to the base station 1002, in some aspects, may be performed by one or more components of a network entity, a network node, or a network device (a single network entity/node/device or a disaggregated network entity/node/device as described above in relation to FIG. 1). Similarly, the functions ascribed to a UE (e.g., the delegate UE 1004 and/or non-delegate UE 1005), in some aspects, may be performed by one or more components of a wireless device supporting communication with a network entity/node/device. Accordingly, references to “transmitting” in the description below may be understood to refer to a first component of the base station 1002 (or the delegate UE 1004 and/or non-delegate UE 1005) outputting (or providing) an indication of the content of the transmission to be transmitted by a different component of the base station 1002 (or the delegate UE 1004 and/or non-delegate UE 1005). Similarly, references to “receiving” in the description below may be understood to refer to a first component of the base station 1002 (or the delegate UE 1004 and/or non-delegate UE 1005) receiving a transmitted signal and outputting (or providing) the received signal (or information based on the received signal) to a different component of the base station 1002 (or the delegate UE 1004 and/or non-delegate UE 1005).

The base station 1002, in some aspects, may transmit, and the delegate UE 1004 may receive, an UL-WUS configuration 1008 (e.g., a configuration associated with a common UL-WUS and/or a UE cooperation group). The delegate UE 1004 may transmit, and the non-delegate UEs 1005 may receive, UL-WUS configuration 1009 (e.g., as separate unicast transmissions or as a multi-cast, groupcast, or broadcast transmission). In some aspects, the base station 1002, the delegate UE 1004, the non-delegate UEs 1005 (which may generally be a set of one or more UEs), and the UE 1006 not ultimately included in the UE cooperation group 1007 may, at 1010, negotiate a group definition and membership, determine one or more delegate UE(s) for a defined/determined group (e.g., a UE cooperation group), and assign/identify/determine a group ID for the determined group. In some aspects, the definition and/or membership of the UE cooperation group 1007 may be determined at 1010 based on camping on a same cell, using a same or similar set of beams, and/or being in a similar location (e.g., within a threshold distance of a particular location or within a threshold distance from a UE such as the delegate UE or a centrally located UE in the cooperation group). In some aspects, the negotiation, determination, and assigning may be based on the configuration for a common UL-WUS (e.g., the UL-WUS configuration 1008) obtained by the UEs in the UE cooperation group 1007 and/or the specific implementation of the common UL-WUS (e.g., SFN UL-WUS, common UL-WUS, independent and/or multiple feedback/SI/SSB transmission, using a “relay-style” delegate UE, etc.). In some aspects, the common UL-WUS may include cell-specific information. The operations at 1010, in some aspects, may be based on various communications (signaling, indications, and/or “handshakes”) that allow the candidate UEs to determine if they belong to a same cooperation and/or coordination group and/or to determine at least one delegate UE (e.g., information relating to delegate selection criteria such as distance from a base station, a link quality/budget with the base station, etc.).

After determining the group configuration and identifying the delegate UE 1004, the non-delegate UEs 1005 may transmit, and the delegate UE 1004 may receive, a first request for SI (e.g., SI request 1012) and a second request for SI (e.g., SI request 1014), where each request for SI may be a request for a different one of a SIB1, an SSB, or OSI. Based on at least one of the SI request 1012 or the SI request 1014, the delegate UE 1004 may determine, at 1016, to transmit a common SFN UL-WUS. For example, the delegate UE 1004 may determine, at 1016, that the delegate UE 1004 does not store the requested SI and/or that a threshold number of requests has been received, where the threshold may be as low as 1 in some aspects. Based on the determination at 1016, the delegate UE 1004 and an additional UE in the UE cooperation group 1007 (e.g., a non-delegate UE 1005 or an additional delegate UE (not shown)) may determine, at 1017, a SFN resource and/or occasion to use to transmit a common SFN UL-WUS 1020 (e.g., a request for SI/SSB). The delegate UE 1004 and the non-delegate UE 1005 may transmit, and the base station may receive the common SFN UL-WUS 1020 including a first common SFN UL-WUS component 1018 transmitted by the delegate UE 1004 and a second common SFN UL-WUS component 1019 transmitted by the non-delegate UE 1005.

The responses to the common SFN UL-WUS 1020 may be received as described in relation to options 920A and/or 920B of FIG. 9. For example, in relation to a first implementation (e.g., associated with individual responses as illustrated in option 920A of FIG. 9), the common SFN UL-WUS 1020 may include an indication of one or more requests for SI/SSB associated with a same and/or different SI/SSB(s) and or one or more directions associated with the one or more requests. The indication in some aspects, may be a group ID (e.g., as negotiated and/or identified at 1010) that identifies the members of the UE cooperation group 1007. Based on the common SFN UL-WUS 1020, the base station 1002 may transmit, and the delegate UE 1004 may receive, feedback (e.g., an ACK indicating that the base station received the common UL-WUS) and forward the feedback (or provide an indication of the content of the feedback) to the non-delegate UEs 1005. In some aspects, the feedback may indicate resources to be monitored by the UEs (e.g., the delegate UE 1004 and the non-delegate UEs 1005) to acquire the SI/SSB. Accordingly, the delegate UE 1004 and the non-delegate UEs 1005 may monitor for the SI. The base station 1002 may transmit, and the delegate UE 1004 and the non-delegate UEs 1005 may receive the requested SI/SSB.

Alternatively, or additionally, in relation to a second implementation (e.g., associated with a single/common response to the delegate UE 1004 as illustrated in option 920B of FIG. 9), the common SFN UL-WUS 1020 may be associated with a “U2N relay” delegate UE (where the delegate UE may not fulfill all the functions of a U2N relay UE, but act as a relay UE in some aspects relating to retrieving the SI/SSB) such that it may not include information regarding the non-delegate UEs associated with (e.g., triggering) the common SFN UL-WUS 1020. In some aspects using a “U2N relay” delegate UE, the base station 1002 may transmit, and the delegate UE 1004 may receive, feedback and/or SI/SSB. The delegate UE 1004 may then provide (e.g., transmit using a wireless transmission using any of a number of different local, short-range, and/or low-power links) SI to non-delegate UEs 1005, where providing the SI may be via unicast (based on TDM), multi-cast/groupcast, and/or broadcast transmission. Based on the SI/SSB acquired via either the individual responses and/or the common response, the non-delegate UE 1005 (as a non-limiting example of a UE in the UE cooperation group 1007) may establish a connection with the base station 1002 (e.g., may transition from an idle/inactive state to a connected/active state). Subsequently, the delegate UE 1004 may detect, at 1030, a trigger event for transmitting a common UL-WUS (or common SFN UL-WUS). As described above the triggering event may be an expiration of locally stored SI, a measurement-based event (see, e.g., Table 2), or a reception of a local UL-WUS (e.g., a SI request from a non-delegate UE in the UE cooperation group 1007) for SI not stored at the delegate UE (or at another delegate and/or non-delegate UE in the UE cooperation group 1007. Based on detecting the triggering event at 1030, the delegate UE 1004 may transmit, and the base station 1002 may receive, a common UL-WUS 1032 for the SI associated with the detected triggering event. In response to the common UL-WUS 1032, the base station 1002 may transmit, and the delegate UE 1004 may receive, SI/SSB 1034. The SI/SSB 1034, in some aspects, may include multiple SIs in a single transmission (with multiplexed information) or in a set of multiple transmissions.

A non-delegate UE 1005 in the UE cooperation group 1007 may transmit, and the delegate UE 1004 may receive, a request for SI (e.g., SI request 1036). In some aspects, the SI request 1036 may also be received by one or more other non-delegate UEs 1005 in the UE cooperation group 1007 or outside the UE cooperation group 1007 that may locally store the requested SI. The non-delegate UE 1005 storing the requested SI, in some aspects, may transmit SI 1043 to the requesting non-delegate UE 1005. In some aspects, the SI request 1036 may be transmitted by the non-delegate UE 1005 based on a failure to receive the SI/SSB as described in relation to options 920A and/or 920B of FIG. 9 (e.g., a failure to receive and/or decode the SI/SSB 932 or the SI 944). Similarly, a UE 1006 not in the UE cooperation group 1007 may transmit, and the delegate UE 1004 may receive, a request for SI (e.g., SI request 1038). The delegate UE 1004, in some aspects, may determine at 1040 to not transmit a common UL-WUS. For example, if the delegate UE 1004 determines that it has the requested SI stored locally (or that it is not the delegate UE for the UE 1006), the delegate UE 1004 may retrieve the locally stored SI and transmit SI 1044 to the requesting non-delegate UE 1005 and transmit SI 1042 to the UE 1006. Based on the SI provided and/or transmitted by the delegate UE 1004, the non-delegate UE 1005 (as a non-limiting example of a UE in the UE cooperation group 1007) and/or the UE 1006 may establish a connection with the base station 1002 (e.g., may transition from an idle/inactive state to a connected/active state).

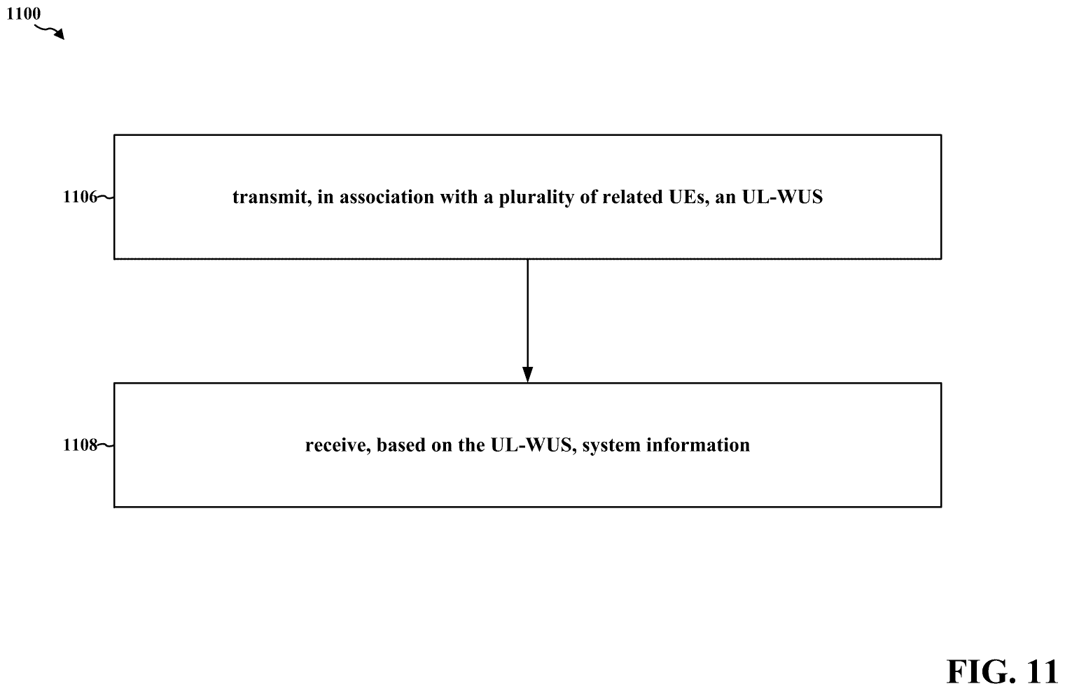

FIG. 11 is a flowchart 1100 of a method of wireless communication. The method may be performed by a (delegate) UE (e.g., the UE 104, 404, 504, 1004; the delegate UE 604, 704, 804, 904; the apparatus 1504). In some aspects, the UE may receive at least one indication that the UE is a delegate UE for a plurality of related UEs. In some aspects, the indication may be part of signaling and/or handshake associated with a UE cooperation and/or coordination group and may be based on a selection that is in turn based on selection criteria (e.g., proximity to a particular cell (a cell providing SI/SSBs), a link quality/budget, a connection status, etc.). For example, each UE in a group of collocated UEs may report a set of characteristics of the UE (e.g., information regarding its own characteristics), and a delegate UE may be determined by each UE independently using the same criteria and the characteristics reported by the UEs in the group of collocated UEs. The UEs may additionally transmit an indication of a locally-selected delegate (a handshake) to ensure coordination. For example, referring to FIGS. 9 and 10, the delegate UE 904 and/or the delegate UE 1004 may receive an indication that it has been selected as the delegate UE for the UE cooperation group 907 and/or 1007 at 910 and/or 1010.

The UE, in some aspects, may receive, from each UE in the plurality of related UEs, a request for the system information and/or detect an event triggering a request for system information. In some aspects, the plurality of related UEs may include all, or a subset of, the UEs in a UE coordination group. In some aspects, additional requests for SI may be received from UEs not included in the plurality of related UEs, e.g., not in the UE coordination group. In some aspects, the requests may be one of UL-WUSs or other types of local requests. For example, referring to FIGS. 9 and 10, the delegate UE 904 and/or the delegate UE 1004 may receive SI request 912 and SI request 914 or SI request 1012 and SI request 1014 or the delegate UE 1004 may receive SI request 1038 from UE 1006. The delegate UE 904 and/or the delegate UE 1004, in some aspects, may detect, at 1030, a trigger event for transmitting a common UL-WUS. In some aspects, the UE may determine whether the UE has the system information (e.g., the system information associated with the plurality of requests and/or the triggering event). In some aspects, the determination may be made for each of a plurality of different types of requested SI independently.

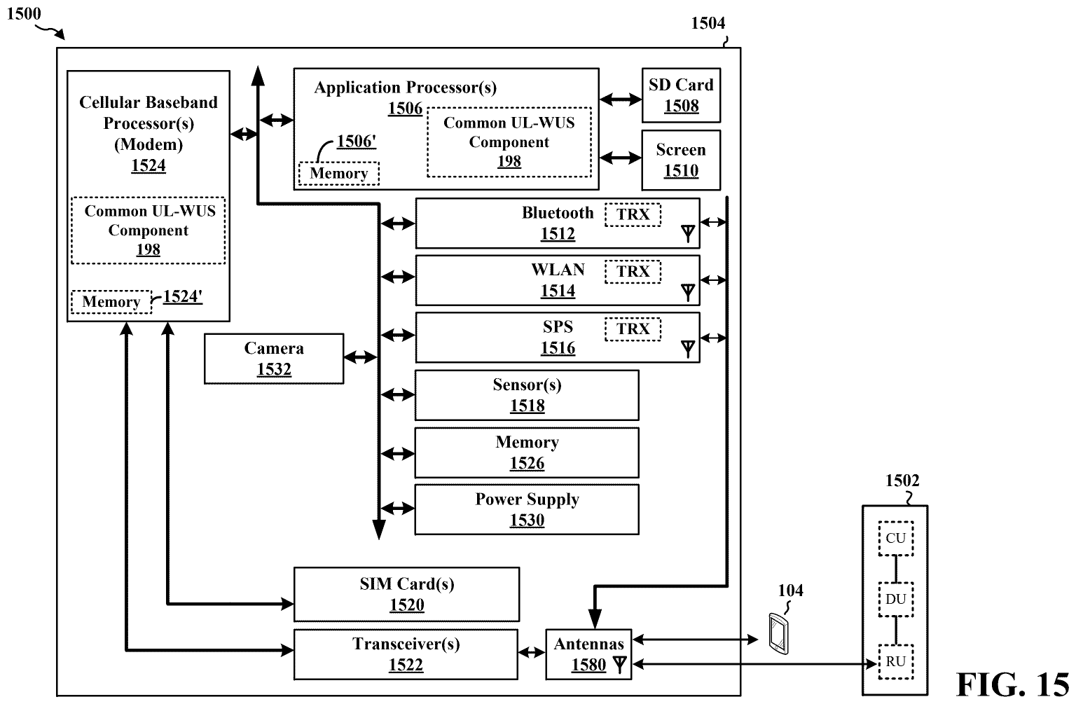

At 1106, the UE may transmit, in association with the plurality of related UEs, an UL-WUS. In some aspects, the UL-WUS may indicate a plurality of directions for transmission of the system information, where each direction in the plurality of directions is associated with a UE in the plurality of related UEs. The transmission at 1106, in some aspects, may be based on the UE determining that it does not have the SI (e.g., that the SI is not stored locally) or that locally stored SI is expired or invalid for other reasons (e.g., a triggering event may invalidate some or all of the locally stored SI). For example, 1106 may be performed by application processor(s) 1506, cellular baseband processor(s) 1524, transceiver(s) 1522, antenna(s) 1580, and/or common UL-WUS component 198 of FIG. 15. In some aspects, the plurality of related UEs may be associated with a group ID. The group ID, in some aspects, may be associated with the plurality of directions and the UL-WUS may include the group ID (e.g., to indicate the plurality of directions). In some aspects, the system information is group-specific. In some aspects, the plurality of directions and/or the group-specific system information may be configured by a network device and/or one or more UE(s) (e.g., delegate UEs) for a set of group IDs associated with a plurality of groups (UE coordination groups). The UL-WUS, in some aspects, may be one of a plurality of UL-WUS transmitted by at least one additional UE in the plurality of related UEs, where the plurality of UL-WUS is associated with a single frequency network transmission (e.g., a common SFN UL-WUS). For example, referring to FIGS. 9 and 10, the delegate UE 904 may determine, at 916 to transmit the common UL-WUS 918 and/or the delegate UE 1004 may determine, at 1016 or 1030 to transmit the common SFN UL-WUS 1020 or the common UL-WUS 1032. In some aspects, the delegate UE 904 may determine, at 916, that the delegate UE 904 does not store the requested SI or the delegate UE 1004 may determine that locally stored SI has expired.

At 1108, the UE may receive, based on the UL-WUS, system information. For example, 1108 may be performed by application processor(s) 1506, cellular baseband processor(s) 1524, transceiver(s) 1522, antenna(s) 1580, and/or common UL-WUS component 198 of FIG. 15. In some aspects, the received system information includes SI for the plurality of related UEs. For example, referring to FIGS. 9 and 10, the delegate UE 904 may transmit common UL-WUS 918, or the delegate UE 1004 may transmit common SFN UL-WUS 1020 or common UL-WUS 1032 and receive SI/SSB 930, feedback and/or SI/SSB 940, and/or SI/SSB 1034.

Once the system information has been received at 1108, or the system information was determined to be stored locally at the delegate UE, the UE may provide the system information to at least one of a first UE in the plurality of related UEs or a second UE not in the plurality of related UEs. The SI may be provided via SL communication or other local, short range, or low power links. For example, referring to FIGS. 9 and 10, the delegate UE 904 may transmit SI 942 and SI 944, or the delegate UE 1004 may transmit SI 1042 and SI 1044. In some aspects, the UE may establish, based on the system information, a connection with a cell providing the system information. In some aspects, this may be omitted if the UE is already in a connected state with the cell from which the system information was received. For example, referring to FIGS. 9 and 10, the delegate UE 904 and/or the delegate UE 1004 may, based on the SI/SSB acquired from the base station 902 and/or 1002, establish a connection with the base station 902 and/or 1002 as described by the example of the non-delegate UE 905.

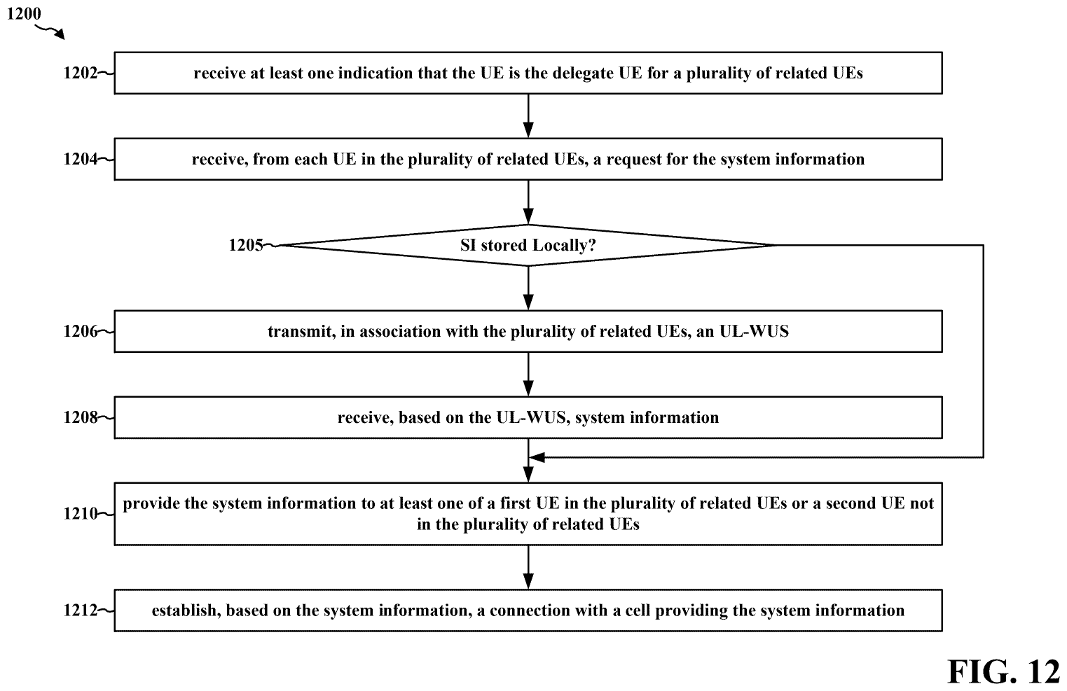

FIG. 12 is a flowchart 1200 of a method of wireless communication. The method may be performed by a (delegate) UE (e.g., the UE 104, 404, 504, 1004; the delegate UE 604, 704, 804, 904; the apparatus 1504). At 1202, the UE may receive at least one indication that the UE is a delegate UE for a plurality of related UEs. For example, 1202 may be performed by application processor(s) 1506, cellular baseband processor(s) 1524, transceiver(s) 1522, antenna(s) 1580, and/or common UL-WUS component 198 of FIG. 15. In some aspects, the indication may be part of signaling and/or handshake associated with a UE cooperation and/or coordination group and may be based on a selection that is in turn based on selection criteria (e.g., proximity to a particular cell (a cell providing SI/SSBs), a link quality/budget, a connection status, etc.). For example, each UE in a group of collocated UEs may report a set of characteristics of the UE (e.g., information regarding its own characteristics), and a delegate UE may be determined by each UE independently using the same criteria and the characteristics reported by the UEs in the group of collocated UEs. The UEs may additionally transmit an indication of a locally-selected delegate (a handshake) to ensure coordination. For example, referring to FIGS. 9 and 10, the delegate UE 904 and/or the delegate UE 1004 may receive an indication that it has been selected as the delegate UE for the UE cooperation group 907 and/or 1007 at 910 and/or 1010.

At 1204, the UE may receive, from each UE in the plurality of related UEs, a request for the system information. In some aspects, the plurality of related UEs may include all, or a subset of, the UEs in a UE coordination group. In some aspects, additional requests for SI may be received from UEs not included in the plurality of related UEs, e.g., not in the UE coordination group. For example, 1204 may be performed by application processor(s) 1506, cellular baseband processor(s) 1524, transceiver(s) 1522, antenna(s) 1580, and/or common UL-WUS component 198 of FIG. 15. In some aspects, the requests may be one of UL-WUSs or other types of local requests. For example, referring to FIGS. 9 and 10, the delegate UE 904 and/or the delegate UE 1004 may receive SI request 912 and SI request 914 or SI request 1012 and SI request 1014 or the delegate UE 1004 may receive SI request 1038 from UE 1006.

At 1205, the UE may determine whether the UE has the requested system information. In some aspects, the determination may be made for each of a plurality of different types of requested SI independently. For example, 1205 may be performed by application processor(s) 1506, cellular baseband processor(s) 1524, transceiver(s) 1522, antenna(s) 1580, and/or common UL-WUS component 198 of FIG. 15. For example, referring to FIGS. 9 and 10, the delegate UE 904 and/or the delegate UE 1004 may receive SI request 912 and SI request 914 or SI request 1012 and SI request 1014 and the delegate UE 904 and/or the delegate UE 1004 may determine at 916 and/or 1016 that the delegate UE does not store the (requested) SI or the delegate UE 1004 may receive SI request 1036 and/or the SI request 1038 and determine at 1040 that the delegate UE 1004 stores the (requested) SI.

If the UE determines that it does not have the SI (e.g., that the SI is not stored locally), the UE, at 1206, may transmit, in association with the plurality of related UEs, an UL-WUS. In some aspects, the UL-WUS may indicate a plurality of directions for transmission of the system information, where each direction in the plurality of directions is associated with a UE in the plurality of related UEs. For example, 1206 may be performed by application processor(s) 1506, cellular baseband processor(s) 1524, transceiver(s) 1522, antenna(s) 1580, and/or common UL-WUS component 198 of FIG. 15. In some aspects, the plurality of related UEs may be associated with a group ID. The group identifier, in some aspects, may be associated with the plurality of directions and the UL-WUS may include the group ID (e.g., to indicate the plurality of directions). In some aspects, the system information is group-specific. In some aspects, the plurality of directions and/or the group-specific system information may be configured by a network device and/or one or more UE(s) (e.g., delegate UEs) for a set of group IDs associated with a plurality of groups (UE coordination groups). The UL-WUS, in some aspects, may be one of a plurality of UL-WUS transmitted by at least one additional UE in the plurality of related UEs, where the plurality of UL-WUS is associated with a single frequency network transmission (e.g., a common SFN UL-WUS). For example, referring to FIGS. 9 and 10, the delegate UE 904 may determine, at 916 to transmit the common UL-WUS 918 and/or the delegate UE 1004 may determine, at 1016 or 1030 to transmit the common SFN UL-WUS 1020 or the common UL-WUS 1032 based on the determination, at 916 and/or 1016 or 1030, that the delegate UE 904 and/or the delegate UE 1004 does not store the requested SI or based on a determination that locally stored SI has expired.

At 1208, the UE may receive, based on the UL-WUS, system information. For example, 1208 may be performed by application processor(s) 1506, cellular baseband processor(s) 1524, transceiver(s) 1522, antenna(s) 1580, and/or common UL-WUS component 198 of FIG. 15. In some aspects, the received system information includes SI for the plurality of related UEs. For example, referring to FIGS. 9 and 10, the delegate UE 904 may transmit common UL-WUS 918, or the delegate UE 1004 may transmit common SFN UL-WUS 1020 or common UL-WUS 1032 and receive SI/SSB 930, feedback and/or SI/SSB 940, and/or SI/SSB 1034.

Once the system information has been received at 1208, or the system information was determined to be stored locally at the delegate UE at 1205, the UE, at 1210 may provide the system information to at least one of a first UE in the plurality of related UEs or a second UE not in the plurality of related UEs. For example, 1210 may be performed by application processor(s) 1506, cellular baseband processor(s) 1524, transceiver(s) 1522, antenna(s) 1580, and/or common UL-WUS component 198 of FIG. 15. The SI may be provided via SL communication or other local, short range, or low power links. For example, referring to FIGS. 9 and 10, the delegate UE 904 may transmit SI 942 and SI 944, or the delegate UE 1004 may transmit SI 1042 and SI 1044.

At 1212, the UE may establish, based on the system information, a connection with a cell providing the system information. In some aspects, this may be omitted if the UE is already in a connected state with the cell from which the system information was received. For example, 1212 may be performed by application processor(s) 1506, cellular baseband processor(s) 1524, transceiver(s) 1522, antenna(s) 1580, and/or common UL-WUS component 198 of FIG. 15. For example, referring to FIGS. 9 and 10, the delegate UE 904 and/or the delegate UE 1004 may, based on the SI/SSB acquired from the base station 902 and/or 1002, establish a connection with the base station 902 and/or 1002 as described by the example of the non-delegate UE 905.

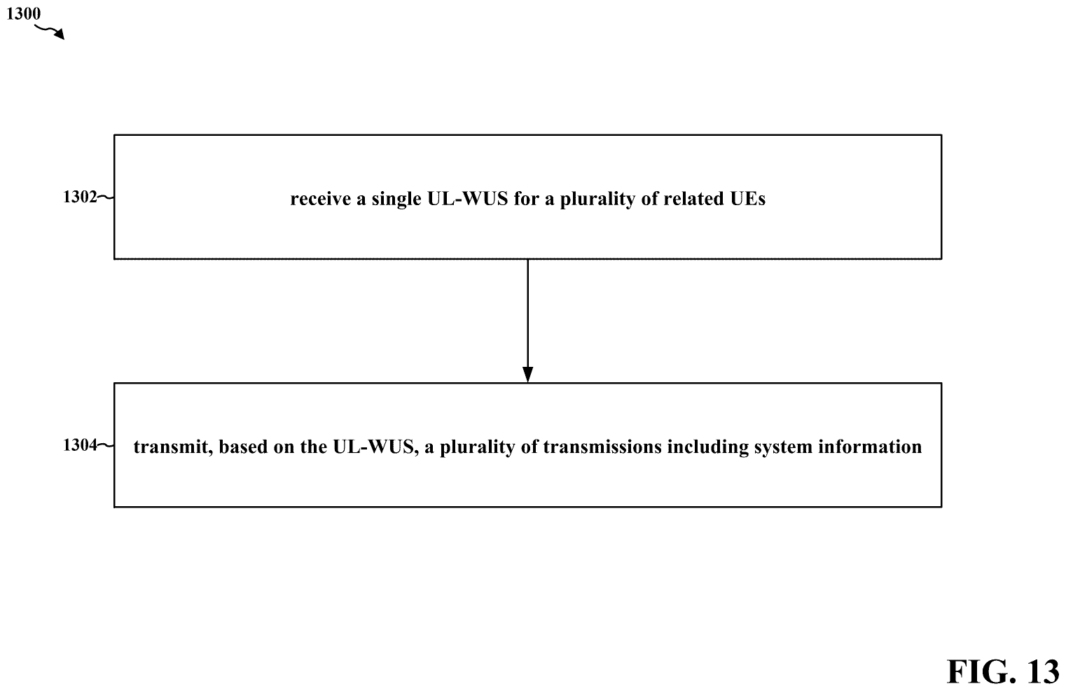

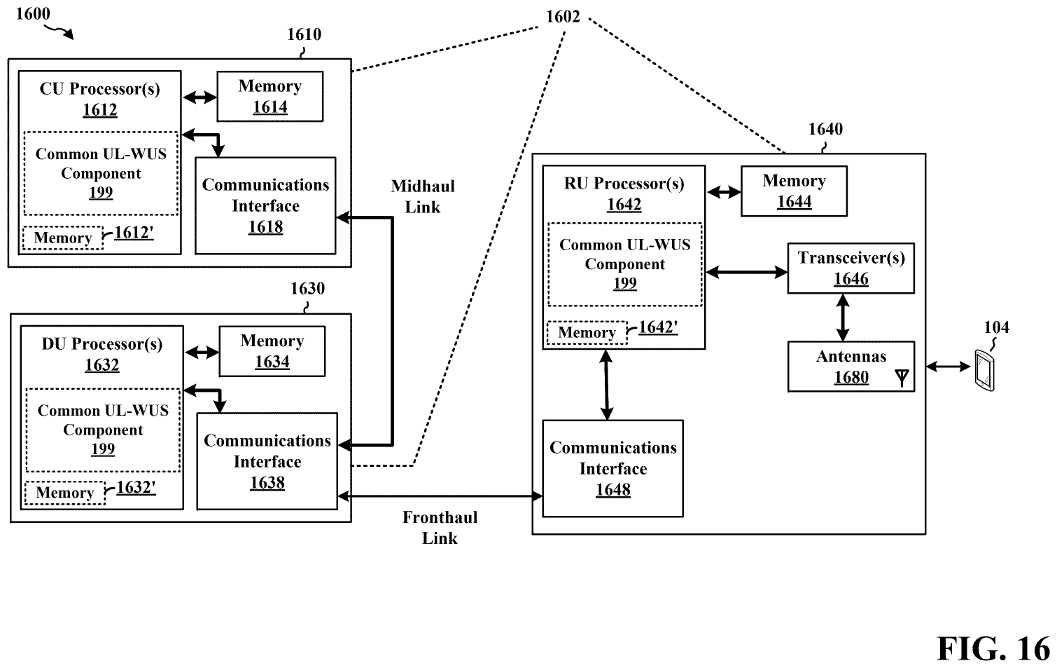

FIG. 13 is a flowchart 1300 of a method of wireless communication. The method may be performed by a base station (e.g., the base station 102, 402, 502, 602, 702, 802, 902, 1002; the network entity 1502, 1602, 1260). At 1302, the base station may receive a single UL-WUS for a plurality of related UEs. For example, 1702 may be performed by CU processor(s) 1612, DU processor(s) 1632, RU processor(s) 1642, transceiver(s) 1646, antenna(s) 1680, and/or common UL-WUS component 199 of FIG. 16. The UL-WUS, in some aspects, may be associated with transmitting system information in a plurality of directions for the plurality of related UEs. In some aspects, the UL-WUS may indicate a plurality of directions for transmission of the system information, where each direction in the plurality of directions is associated with a UE in the plurality of related UEs. In some aspects, the plurality of related UEs may be associated with a group ID. The group ID, in some aspects, may be associated with the plurality of directions and the UL-WUS may include the group ID (e.g., to indicate the plurality of directions). In some aspects, the system information is group-specific. In some aspects, the plurality of directions and/or the group-specific system information may be configured by the base station and/or one or more UE(s) (e.g., delegate UEs) for a set of group IDs associated with a plurality of groups (UE coordination groups). The UL-WUS, in some aspects, may be one of a plurality of UL-WUS transmitted by at least one additional UE in the plurality of related UEs, where the plurality of UL-WUS is associated with a single frequency network transmission (e.g., a common SFN UL-WUS). For example, referring to FIGS. 9 and 10, the base station 902 and/or the base station 1002 may receive the common UL-WUS, the common SFN UL-WUS 1020, or the common UL-WUS 1032.

At 1304, the base station may transmit, based on the UL-WUS, a plurality of transmissions including system information. For example, 1704 may be performed by CU processor(s) 1612, DU processor(s) 1632, RU processor(s) 1642, transceiver(s) 1646, antenna(s) 1680, and/or common UL-WUS component 199 of FIG. 16. In some aspects, the plurality of transmissions may be based on the group ID included in the UL-WUS or other indications of a plurality of directions and/or SI associated with the UL-WUS. For example, referring to FIGS. 9 and 10, the base station 902 and/or the base station 1002 may transmit SI/SSB 930, 931, and 932, feedback and/or SI/SSB 940, and/or SI/SSB 1034 in response to the common UL-WUS 918, the common SFN UL-WUS 1020, or the common UL-WUS 1032.

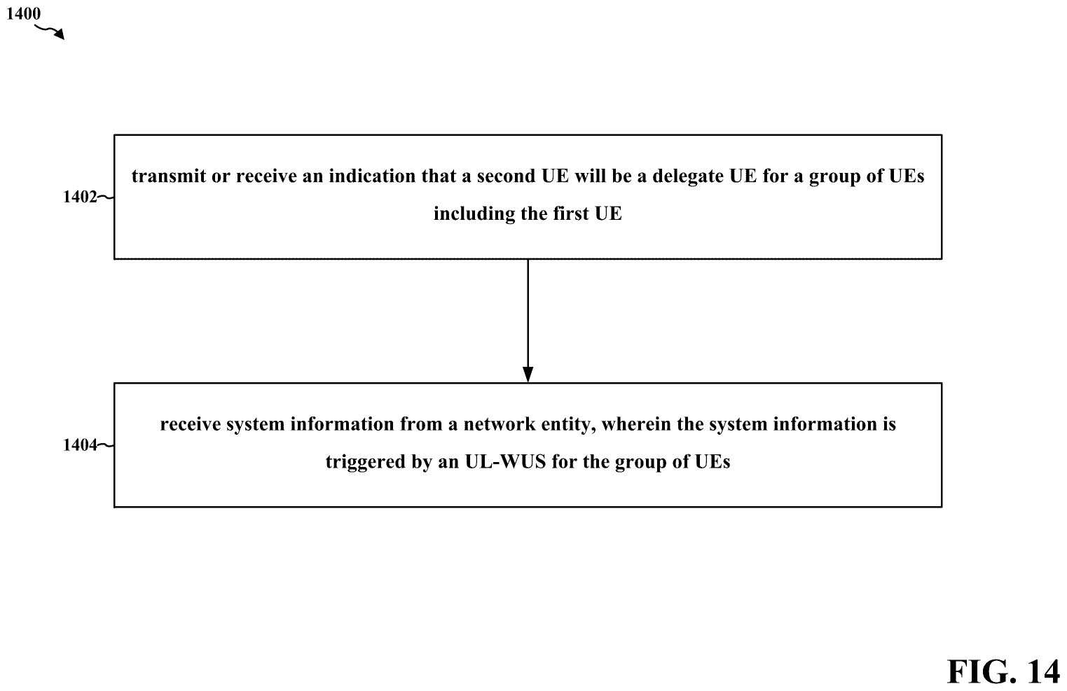

FIG. 14 is a flowchart 1400 of a method of wireless communication. The method may be performed by a (non-delegate) UE (e.g., the UE 104, 404, 504; the non-delegate UE 605, 805, 905, 1005; the additional UEs 705; the apparatus 1504). At 1402, the UE may transmit or receive an indication that a second UE will be a delegate UE for a group of UEs including the first UE. For example, 1402 may be performed by application processor(s) 1506, cellular baseband processor(s) 1524, transceiver(s) 1522, antenna(s) 1580, and/or common UL-WUS component 198 of FIG. 15. In some aspects, the indication may be based on a selection that is in turn based on selection criteria (e.g., proximity to a particular cell (a cell providing SI/SSBs), a link quality/budget, a connection status, etc.). For example, each UE in a group of collocated UEs may report a set of characteristics of the UE (e.g., information regarding its own characteristics), and a delegate UE may be determined by each UE independently using the same criteria and the characteristics reported by the UEs in the group of collocated UEs. The UEs may additionally transmit an indication of a locally-selected delegate (a handshake) to ensure coordination. For example, referring to FIGS. 9 and 10, the non-delegate UE 905 and/or the non-delegate UE 1005 may transmit and/or receive an indication of a selected delegate UE for the UE cooperation group 907 and/or 1007 at 910 and/or 1010.

At 1404, the UE may receive system information from a network entity. In some aspects, the system information may be triggered by an UL-WUS for the group of UEs. For example, 1404 may be performed by application processor(s) 1506, cellular baseband processor(s) 1524, transceiver(s) 1522, antenna(s) 1580, and/or common UL-WUS component 198 of FIG. 15. The UL-WUS for the group of UEs, in some aspects, may indicate a plurality of directions for transmission of the system information, where each direction in the plurality of directions is associated with a UE in the group of UEs including the UE (e.g., a plurality of related UEs). In some aspects, the plurality of related UEs may be associated with a group ID. The group ID, in some aspects, may be associated with the plurality of directions and the UL-WUS may include the group ID (e.g., to indicate the plurality of directions). In some aspects, the system information is group-specific. In some aspects, the plurality of directions and/or the group-specific system information may be configured by a network device and/or one or more UE(s) (e.g., delegate UEs) for a set of group IDs associated with a plurality of groups (UE coordination groups). The UL-WUS, in some aspects, may be one of a plurality of UL-WUS transmitted by at least one additional UE in the plurality of related UEs, where the plurality of UL-WUS is associated with a single frequency network transmission (e.g., a common SFN UL-WUS). For example, referring to FIG. 9, the non-delegate UE 905 may receive SI/SSB 931 or SI/SSB 932 based on the common UL-WUS 918.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize one or more antennas 1580 for communication. The cellular baseband processor(s) 1524 communicates through the transceiver(s) 1522 via the one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the common UL-WUS component 198 may be configured to transmit, in association with a plurality of related UEs, an UL-WUS and receive, based on the UL-WUS, system information. In certain aspects, the common UL-WUS component 198 may be configured to transmit or receive an indication that a second UE will be a delegate UE for a group of UEs including the first UE and receive system information from a network entity, where the system information is triggered by an UL-WUS for the group of UEs. The common UL-WUS component 198 may be within the cellular baseband processor(s) 1524, the application processor(s) 1506, or both the cellular baseband processor(s) 1524 and the application processor(s) 1506. The common UL-WUS component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for transmitting, in association with a plurality of related UEs, an uplink (UL) wake up signal (WUS) (UL-WUS). The apparatus 1504, and in particular the cellular baseband processor(s) 1524 and/or the application processor(s) 1506, may include means for receiving, based on the UL-WUS, system information. The apparatus 1504, and in particular the cellular baseband processor(s) 1524 and/or the application processor(s) 1506, may include means for providing the received system information to at least one other UE in the plurality of related UEs. The apparatus 1504, and in particular the cellular baseband processor(s) 1524 and/or the application processor(s) 1506, may include means for receiving at least one indication that the UE is the delegate UE for the plurality of related UEs. The apparatus 1504, and in particular the cellular baseband processor(s) 1524 and/or the application processor(s) 1506, may include means for providing the system information to at least one of a first UE in the plurality of related UEs or a second UE not in the plurality of related UEs. The apparatus 1504, and in particular the cellular baseband processor(s) 1524 and/or the application processor(s) 1506, may include means for receiving, from each UE in the plurality of related UEs, a request for the system information. The apparatus 1504, and in particular the cellular baseband processor(s) 1524 and/or the application processor(s) 1506, may include means for determining that the UE does not have the system information. The apparatus 1504, and in particular the cellular baseband processor(s) 1524 and/or the application processor(s) 1506, may include means for establishing, based on the system information, a connection with a cell providing the system information. The apparatus 1504, and in particular the cellular baseband processor(s) 1524 and/or the application processor(s) 1506, may include means for transmitting or receiving an indication that a second UE will be a delegate UE for a group of UEs including the first UE. The apparatus 1504, and in particular the cellular baseband processor(s) 1524 and/or the application processor(s) 1506, may include means for receiving system information from a network entity, wherein the system information is triggered by an uplink wake-up signal (WUS) for the group of UEs. The apparatus 1504 may further include means for performing any of the aspects described in connection with the flowcharts in FIG. 11, 12, or 14, and/or performed by the UE in the communication flows of FIGS. 9 and 10. The means may be the common UL-WUS component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the common UL-WUS component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, one or more antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the common UL-WUS component 199 may be configured to receive a single UL-WUS for a plurality of related UEs; and transmit, based on the UL-WUS, a plurality of transmissions including system information. The common UL-WUS component 199 may be within one or more processors of one or more of the CU 1610, DU 1630, and the RU 1640. The common UL-WUS component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for receiving a single uplink (UL) wake up signal (WUS) (UL-WUS) for a plurality of related UEs. The network entity 1602 may include means for transmitting, based on the UL-WUS, a plurality of transmissions including system information. The network entity 1602 may further include means for performing any of the aspects described in connection with the flowchart in FIG. 13, and/or performed by the base station in the communication flows of FIG. 9 or 10. The means may be the common UL-WUS component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 9, 10, and 13.

Various aspects relate generally to a scheme to effectively, for a group of UEs in idle/inactive mode, send UL-WUS through UE delegation and/or cooperation. Some aspects more specifically relate to a delegate UE in a UE cooperation framework (e.g., in a UE cooperation group) that sends UL-WUS for on-demand SSB or OSI to avoid multiple UEs sending independent (different) requests to the network. For example, instead of having multiple UEs send multiple WUS requests for the base station (e.g., a NES cell) one delegate UE may send a common UL-WUS request on behalf of the group. In some aspects, to increase the coverage of the UL-WUS multiple UEs can send the same message as a SFN transmission (e.g., a coherently received signal at the base station transmitted by multiple UEs within the UE cooperation group), or use one delegate UE that is closer to the base station and/or has a stronger link/connection. The delegate UE, in some aspects, may also share the base station feedback (e.g., may provide system information received from the base station to the other members of the UE cooperation group or may provide information regarding an ACK related to the common UL-WUS). In some examples, a wireless device such as a UE or component thereof may be configured to transmit, in association with, or on behalf of, a plurality of related UEs, an UL-WUS and receive, based on the UL-WUS, system information (e.g., SIB1 or OSI). In some aspects, a network node or network device such as a base station or component thereof may be configured to receive a single UL-WUS for a plurality of related UEs; and transmit, based on the UL-WUS, a plurality of transmissions including system information. In some examples, a wireless device such as a UE or component thereof may be configured to transmit or receive an indication that a second UE will be a delegate UE for a group of UEs including the first UE and receive system information from a network entity, where the system information is triggered by an UL-WUS for the group of UEs transmitted by the delegate UE.

Particular aspects of the subject matter described in this disclosure can be implemented to realize one or more of the following potential advantages. In some examples, by identifying a UE cooperation group for receiving on-demand SI and using one or more delegate UEs to transmit an UL-WUS, the described techniques can be used to reduce a power consumption and overhead associated with the retrieval of SI.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: transmitting, in association with a plurality of related UEs, an uplink (UL) wake up signal (WUS) (UL-WUS); and receiving, based on the UL-WUS, system information.

Aspect 2 is the method of aspect 1, wherein the UL-WUS indicates a plurality of directions for transmission of the system information, wherein each direction in the plurality of directions is associated with a UE in the plurality of related UEs.

Aspect 3 is the method of aspect 2, wherein the plurality of related UEs is associated with a group identifier, the group identifier is associated with the plurality of directions, and the UL-WUS includes the group identifier.

Aspect 4 is the method of aspect 3, wherein the system information is group-specific.

Aspect 5 is the method of any of aspects 1 to 4, further comprising: providing the received system information to at least one other UE in the plurality of related UEs.

Aspect 6 is the method of any of aspects 1 to 5, wherein the UE is a delegate UE for the plurality of related UEs, the method further comprising: receiving at least one indication that the UE is the delegate UE for the plurality of related UEs.

Aspect 7 is the method of any of aspects 1 to 6, further comprising: providing the system information to at least one of a first UE in the plurality of related UEs or a second UE not in the plurality of related UEs.

Aspect 8 is the method of any of aspects 1 to 7, further comprising: receiving, from each UE in the plurality of related UEs, a request for the system information.

Aspect 9 is the method of any of aspects 1 to 8, wherein the UL-WUS is one of a plurality of UL-WUS transmitted by at least one additional UE in the plurality of related UEs, wherein the plurality of UL-WUS is associated with a single frequency network transmission.

Aspect 10 is the method of any of aspects 1 to 9, further comprising: determining that the UE does not have the system information, wherein transmitting the UL-WUS is based on the determination.

Aspect 11 is the method of any of aspects 1 to 10, further comprising: establishing, based on the system information, a connection with a cell providing the system information.

Aspect 12 is a method of wireless communication at a network device, comprising: receiving a single uplink (UL) wake up signal (WUS) (UL-WUS) for a plurality of related UEs; and transmitting, based on the UL-WUS, a plurality of transmissions including system information.

Aspect 13 is a method of wireless communication at a first user equipment (UE), comprising: transmitting or receiving an indication that a second UE will be a delegate UE for a group of UEs including the first UE; and receiving system information from a network entity, wherein the system information is triggered by an uplink wake-up signal (WUS) for the group of UEs.

Aspect 14 is an apparatus for wireless communication at a device including a memory and at least one processor coupled to the memory and, based at least in part on information stored in the memory, the at least one processor is configured to implement any of aspects 1 to 11.

Aspect 15 is the apparatus of aspect 14, further including a transceiver or an antenna coupled to the at least one processor.

Aspect 16 is an apparatus for wireless communication at a device including means for implementing any of aspects 1 to 11.

Aspect 17 is a computer-readable medium (e.g., a non-transitory computer-readable medium) storing computer executable code, where the code when executed by a processor causes the processor to implement any of aspects 1 to 11.

Aspect 18 is an apparatus for wireless communication at a device including a memory and at least one processor coupled to the memory and, based at least in part on information stored in the memory, the at least one processor is configured to implement aspect 12.

Aspect 19 is the apparatus of aspect 18, further including a transceiver or an antenna coupled to the at least one processor.

Aspect 20 is an apparatus for wireless communication at a device including means for implementing aspect 12.

Aspect 21 is a computer-readable medium (e.g., a non-transitory computer-readable medium) storing computer executable code, where the code when executed by a processor causes the processor to implement aspect 12.

Aspect 22 is an apparatus for wireless communication at a device including a memory and at least one processor coupled to the memory and, based at least in part on information stored in the memory, the at least one processor is configured to implement aspect 13.

Aspect 23 is the apparatus of aspect 22, further including a transceiver or an antenna coupled to the at least one processor.

Aspect 24 is an apparatus for wireless communication at a device including means for implementing aspect 13.

Aspect 25 is a computer-readable medium (e.g., a non-transitory computer-readable medium) storing computer executable code, where the code when executed by a processor causes the processor to implement aspect 13.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
transmit, in association with a plurality of related UEs, an uplink (UL) wake up signal (WUS) (UL-WUS); and
receive, based on the UL-WUS, system information.

2. The apparatus of claim 1, wherein the UL-WUS indicates a plurality of directions for transmission of the system information, wherein each direction in the plurality of directions is associated with a respective UE in the plurality of related UEs.

3. The apparatus of claim 2, wherein the plurality of related UEs is associated with a group identifier, the group identifier is associated with the plurality of directions, and the UL-WUS includes the group identifier.

4. The apparatus of claim 3, wherein the system information is group-specific.

5. The apparatus of claim 1, further comprising a transceiver coupled to the at least one processor, the transceiver being configured to:
provide, via the transceiver, the received system information to at least one other UE in the plurality of related UEs.

6. The apparatus of claim 1, wherein the UE is a delegate UE for the plurality of related UEs, and wherein the at least one processor, individually or in any combination, is further configured to:
receive at least one indication that the UE is the delegate UE for the plurality of related UEs.

7. The apparatus of claim 1, wherein the at least one processor, individually or in any combination, is further configured to:
provide the system information to at least one of a first UE in the plurality of related UEs or a second UE not in the plurality of related UEs.

8. The apparatus of claim 1, wherein the at least one processor, individually or in any combination, is further configured to:
receive, from each UE in the plurality of related UEs, a request for the system information.

9. The apparatus of claim 1, wherein the UL-WUS is one of a plurality of UL-WUS transmitted by at least one additional UE in the plurality of related UEs, wherein the plurality of UL-WUS is associated with a single frequency network transmission.

10. The apparatus of claim 1, wherein the at least one processor, individually or in any combination, is further configured to:
determine that the UE does not have the system information, wherein to transmit the UL-WUS the at least one processor, individually or in any combination, is further configured to transmit the UL-WUS based on a determination that the UE does not have the system information.

11. The apparatus of claim 1, wherein the at least one processor, individually or in any combination, is further configured to:
establish, based on the system information, a connection with a cell providing the system information.

12. A method of wireless communication at a user equipment (UE), comprising:
transmitting, in association with a plurality of related UEs, an uplink (UL) wake up signal (WUS) (UL-WUS); and
receiving, based on the UL-WUS, system information.

13. The method of claim 12, wherein the UL-WUS indicates a plurality of directions for transmission of the system information, wherein each direction in the plurality of directions is associated with a respective UE in the plurality of related UEs.

14. The method of claim 13, wherein the plurality of related UEs is associated with a group identifier, the group identifier is associated with the plurality of directions, and the UL-WUS includes the group identifier, and wherein the system information is group-specific.

15. The method of claim 12, wherein the UE is a delegate UE for the plurality of related UEs, the method further comprising:
receiving at least one indication that the UE is the delegate UE for the plurality of related UEs; and
receiving, from each UE in the plurality of related UEs, a request for the system information.

16. The method of claim 12, further comprising:
providing the system information to at least one of a first UE in the plurality of related UEs or a second UE not in the plurality of related UEs.

17. The method of claim 12, wherein the UL-WUS is one of a plurality of UL-WUS transmitted by at least one additional UE in the plurality of related UEs, wherein the plurality of UL-WUS is associated with a single frequency network transmission.

18. The method of claim 12, further comprising:
determining that the UE does not have the system information, wherein transmitting the UL-WUS is based on a determination that the UE does not have the system information.

19. The method of claim 12, further comprising:
establishing, based on the system information, a connection with a cell providing the system information.

20. A computer-readable medium storing computer executable code at a user equipment (UE), the code when executed by a processor causes the processor to:
transmit, in association with a plurality of related UEs, an uplink (UL) wake up signal (WUS) (UL-WUS); and
receive, based on the UL-WUS, system information.
